(19) United States
(12) Patent Application Publication
(10) Pub. No.: US 2017/0244705 A1
(43) Pub. Date: Aug. 24, 2017

(54) METHOD OF USING CONVERGED CORE NETWORK SERVICE, UNIVERSAL CONTROL ENTITY, AND CONVERGED CORE NETWORK SYSTEM

(71) Applicant: ELECTRONICS AND TELECOMMUNICATIONS RESEARCH INSTITUTE, Daejeon (KR)

(72) Inventors: Jeounglak HA, Daejeon-si (KR); Yoo Hwa KANG, Daejeon-si (KR); Chang Ki KIM, Daejeon-si (KR); No Ik PARK, Daejeon-si (KR); Young Il CHOI, Daejeon-si (KR)

(21) Appl. No.: 15/252,651

(22) Filed: Aug. 31, 2016

(30) Foreign Application Priority Data
Feb. 18, 2016 (KR) 10-2016-0019316

(51) Int. Cl. H04L 29/06; H04W 12/06

(52) U.S. Cl. CPC H04L 63/0876; H04L 63/061; H04W 12/06; H04L 63/062; H04L 61/6022

(57) ABSTRACT

A method of using a converged core network service, a universal control entity (UCE), and a converged core network system. The method includes establishing, by a terminal, a signaling connection with a converged core network supporting a plurality of access networks through a first access network, and after establishing the signaling connection, using, by the terminal, a data service through a second access network by reusing at least one of authentication information authenticated and resource information allocated upon establishing the signaling connection through the first access network.

### CROSS-REFERENCE TO RELATED APPLICATION(S)

This application claims priority to Korean Patent Application No. 10-2016-0019316, filed Feb. 18, 2016, in the Korean Intellectual Property Office, the disclosure of which is incorporated herein by reference in its entirety.

### BACKGROUND

1. Field

The following description relates to fixed-mobile convergence (FMC) core network technology, and more particularly, to a signaling technology in an FMC core network.

2. Description of Related Art

FMC is a network technology which enables a service user to receive a consistent and seamless service regardless of the type of an access network in a wired and wireless communications network environment in which various access networks are configured. In an FMC environment, a signaling method irrelevant to access network technologies is necessary to provide a consistent communication service through different access networks. This is because network complexity increases when different signaling methods are employed in respective access networks.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a method of using a converged core network service, a universal control entity (UCE), and a converted core network system.

In one general aspect, a method of using a converged core network service includes: establishing, by a terminal, a signaling connection with a converged core network supporting a plurality of access networks through a first access network; and after establishing the signaling connection, using, by the terminal, a data service through a second access network by reusing at least one of authentication information authenticated and resource information allocated upon establishing the signaling connection through the first access network.

The using of the data service may include authenticating the terminal for use of the data service through the second access network, and the terminal may be authenticated when the terminal transmits a message encoded using an authentication key assigned by the converged core network upon the terminal's establishment of the signaling connection through the first access network to the converged core network through the second access network and the converged core network decodes the message received from the terminal using the authentication key assigned by the converged core network upon the terminal's establishment of the signaling connection through the first access network.

The using of the data service may include: transmitting, by the terminal, a service request including a temporary identifier (ID) to the second access network, and transmitting, by the second access network, a session creation request message including the temporary ID to a UCE; and authenticating, by the UCE, the terminal using the temporary ID included in the session creation request message received from the second access network, and the temporary ID may be information generated and transmitted to the terminal by the UCE when the terminal requests the signaling connection through the first access network. The temporary ID may be a globally unique temporary identifier (GUTI).

The using of the data service may further include: identifying, by the second access network, a media access control (MAC) address of the terminal in a frame including a service request message; and authenticating, by the UCE, the terminal using the identified MAC address together with the temporary ID.

The using of the data service may include transmitting, by the second access network, a service response to a service request of the terminal to the terminal, assigning an address identical to an Internet protocol (IP) address assigned to the terminal by a UCE upon the terminal's establishment of the signaling connection through the first access network, and transmitting the address through the service response.

The using of the data service may include ciphering data of a section between the terminal and the second access network when the second access network receives, from a UCE, index information of a cipher key exchanged between the terminal and the UCE upon the terminal's establishment of the signaling connection through the first access network and reuses the index information, or the second access network receives the index information of the cipher key from the first access network and reuses the index information.

The establishing of the signaling connection may include: transmitting, by the terminal, a connection request message to a UCE; requesting, by the UCE receiving the connection request message, subscriber information from a home subscriber server (HSS) and receiving subscriber information from the HSS; transmitting, by the UCE, an authentication request message including authentication key information in the subscriber information to the terminal and receiving the authentication information from the terminal; and assigning, by the UCE authenticating a subscriber, an IP address to the terminal and transmitting an access acceptance message including the assigned IP address to the terminal. The subscriber information may include MAC information for wireless fidelity (WiFi) authentication or port information for Fixed authentication together with the authentication key information of the subscriber.

The establishing of the signaling connection may further include exchanging, by the UCE authenticating the subscriber, index information of a cipher key to be used for ciphering data with the terminal through a security mode command procedure. The establishing of the signaling connection may further include, for authentication of the terminal, assigning, by the UCE, a temporary ID and transferring the assigned temporary ID to the terminal through the access acceptance message.

The method may further include establishing a bidirectional tunnel between the second access network and a converged gateway (CGW) using a tunnel end identifier (TEID). The method may further include: registering, by a CGW, a routing path to an IP address of the terminal through a second delivery network in a routing table of the CGW; and registering, by the second delivery network, a routing path to the IP address of the terminal through the CGW in a routing table of the second delivery network.

The first access network may be a representative access network among a mobile communication network, a wireless communication network, and a wired communication network, the second access network may be at least one of a mobile communication network, a wireless communication network, and a wired communication network, and the first access network and the second access network may be identical to or different from each other.

In another general aspect, a UCE includes: an authentication manager configured to authenticate a terminal requesting a signaling connection with a converged core network through a first access network, and authenticate the terminal, which connects to the converged core network through a second access network to use a data service of the converged core network after the signaling connection is established, by reusing authentication information used to establish the signaling connection; and a resource manager configured to transmit information on resource allocation to the terminal requesting the signaling connection through the first access network, and cause the terminal to reuse the resource information upon access through the second access network.

The authentication manager may generate and transmit a temporary ID to the terminal when the terminal requests the signaling connection through the first access network, and authenticate, when a session creation request message including the temporary ID is received from the terminal through the second access network after the signaling connection is established, the terminal using the temporary ID included in the received session creation request message.

The authentication manager may exchange index information of a cipher key with the terminal when the terminal requests the signaling connection through the first access network, and transfer the index information of the cipher key exchanged with the terminal to the second access network, so that data is ciphered by reusing the index information of the cipher key in a section between the terminal and the second access network when the terminal uses the data service through the second access network after the signaling connection is established.

The resource manager may assign an IP address to the terminal when the terminal requests the signaling connection through the first access network, and transmit a connection response together with the assigned IP address to the terminal, so that the assigned IP address of the terminal is reused when the terminal uses the data service through the second access network after the signaling connection is established.

In still another general aspect, a converted core network system includes: a terminal; a plurality of access networks to which the terminal connects; and a converged core network configured to support the plurality of access networks and provide a data service to the terminal through a second access network by reusing at least one of authentication information authenticated and resource information allocated when the terminal establishes a signaling connection with the converged core network through a first access network.

Other features and aspects will be apparent from the following detailed description, the drawings, and the claims.

### BRIEF DESCRIPTION OF THE DRAWINGS

FIG. 1 shows a configuration of a converged network system according to an exemplary embodiment of the present invention.

FIGS. 2A to 2E show examples of signaling and data connection paths for respective access networks in a converged network.

FIG. 3A is a structure diagram showing an example of a protocol stack for signaling according to an exemplary embodiment of the present invention.

FIG. 3B is a structure diagram showing an example of a protocol stack for data according to an exemplary embodiment of the present invention.

FIG. 4 is a reference diagram showing relationships between a non-access stratum (NAS) layer and respective access technologies.

FIG. 5 is a structure diagram showing relationships between respective access technologies and a public data network (PDN) according to an exemplary embodiment of the present invention.

FIG. 6 is a block diagram of a universal control entity (UCE) according to an exemplary embodiment of the present invention.

FIG. 7 is a sequence diagram showing a process in which a user establishes a signaling connection through Fifth generation (5G).

FIG. 8 is a sequence diagram showing a process in which a user uses data through 5G.

FIG. 9 is a sequence diagram showing a process in which a user uses data through wireless fidelity (WiFi).

FIG. 10 is a sequence diagram showing a process in which a user uses data through Fixed.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Advantages and features of the present invention and a method of achieving the same will clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Throughout the drawings, like reference numbers refer to like elements.

Also, descriptions of well-known functions and constructions may be omitted for increased clarity and conciseness. The terms used in the following description are terms defined in consideration of functions in exemplary embodiments of the present invention and may vary depending on an intention of a user or an operator, a practice, or so on. Therefore, definitions of terms used herein should be made based on content throughout the specification.

Each block of the appended block diagrams and flowcharts and combinations thereof can be implemented by computer program instructions (an execution engine). These computer program instructions may be provided to a processor of a general purpose computer, special purpose computer, or another programmable data processing apparatus to produce a machine, so that the instructions, which execute via the processor of the computer or other programmable data processing apparatus, create a means for implementing the functions specified in each block of the block diagrams or flowcharts.

These computer program instructions may also be stored in a computer-usable or computer-readable memory that may direct a computer or another programmable data processing apparatus to function in a particular manner, so that the instructions stored in the computer-usable or computer-readable memory produce an article of manufacture including instructions that implement the function specified in each block of the block diagrams or flowcharts.

The computer program instructions may also be loaded onto a computer or another programmable data processing apparatus to cause a series of operations to be performed on the computer or other programmable apparatus to produce a computer implemented process so that the instructions that execute on the computer or other programmable data processing apparatus provide operations for implementing, the functions specified in each block of the block diagrams or flowcharts.

Also, each block or each operation may represent a module, segment, or portion of code, which includes one or more executable instructions for implementing the specified logical functions. It should also be noted that in other implementations, the functions noted in the blocks or operations may occur out of the order. For example, two blocks or operations shown in succession may, in fact, be executed substantially concurrently or the blocks or operations may sometimes be executed in the reverse order, depending on the functionality involved.

Hereinafter, exemplary embodiments of the present invention will be described in detail with reference to the accompanying drawings. However, the present invention is not limited to the embodiments described herein, and may be embodied in many different forms. These embodiments are provided so that this disclosure will be through and complete, and will fully convey the scope of the invention to those of ordinary skill in the art.

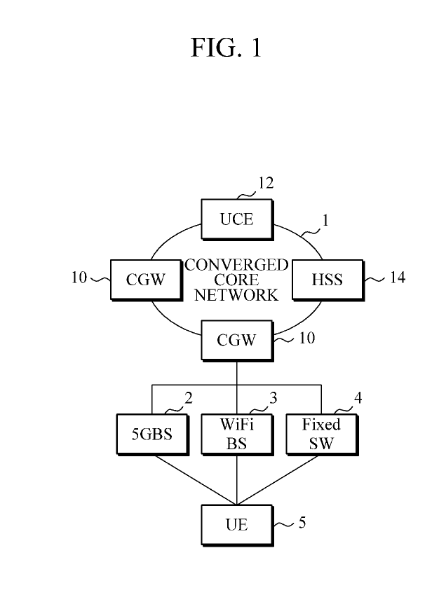

FIG. 1 shows a configuration of a converged network system according to an exemplary embodiment of the present invention.

Referring to FIG. 1, a converged network system includes a converged core network 1, a plurality of access networks, and a terminal.

The converged core network 1 includes converged gateways (CGWs) 10, a universal control entity (UCE) 12, and a home subscriber server (HSS) 14.

The CGWs 10 take charge of data processing in the converged core network 1, the UCE 12 takes charge of control of the converged core network 1, and the HSS 14 stores subscriber information. As an example, according to Third generation partnership project (3GPP) long term evolution (LTE), the CGWs 10 serve as serving gateways (SGWs)/packet data network (PDN) gateways (PGWs), and the UCE 12 serves as a mobility management entity (MME). FIG. 1 shows a Fifth generation (5G) network, a wireless fidelity (WiFi) network, and a Fixed network as examples of access networks, but the access networks are not limited thereto. 5G denotes a new radio access technology which will appear after Fourth generation (4G), WiFi denotes a radio access technology of the Institute of Electrical and Electronic Engineers (IEEE) 802.11 series, and Fixed denotes a wired Internet protocol (IP) access technology. In this specification, a case of a 5G access network is described as an example, but the present invention may also be applied to various radio access technologies, such as 3G, 4G, etc., in the same way.

An access network is any one of a mobile communication network, a wireless communication network, and a wired communication network. For example, the access networks may be a 5G base station (5GBS) 2, a WiFi base station (WiFiBS) 3, and a Fixed switch (FixedSW) 4. The 5GBS 2 is a BS supporting the 5G radio access technology, the WiFiBS 3 is a BS supporting WiFi, and the FixedSW 4 is a layer 3 (L3) switch supporting a wired IP access network. In this specification, a base station (BS) may denote an access point (AP), a radio access station (RAS), a node BS (NodeB), an evolved nodeB (eNodeB), a base transceiver station (BTS), a mobile multihop relay (MMR)-BS, etc., and may include functions of all or some of an AP, an RAS, a NodeB, an eNodeB, a BTS, an MMR-BS, and so on.

FIG. 1 shows that the 5GBS 2, the WiFiBS 3, and the FixedSW 4 are connected to the converged core network 1 through a CGW 10, but the 5GBS 2, the WiFiBS 3, and the FixedSW 4 may directly access the UCE 12.

User equipment (UE) 5 is one of terminals used by users, and a terminal may denote a mobile station (MS), a mobile terminal (MT), a subscriber station (SS), a portable subscriber station (PSS), an access terminal (AT), etc. besides the UE 5. Alternatively, a terminal may include functions of all or some of an MT, an SS, a PSS, UE, an AT, and so on. Further, a terminal denotes any one or both of a terminal and a user who uses the terminal. For convenience of description, a case in which the terminal is the UE 5 will be described.

The present invention proposes a technology for efficiently supporting access of a user through various access networks in a converged core network which supports various access networks as shown in FIG. 1. In particular, the present invention proposes a technology for a terminal to reuse authentication information authenticated or resource information allocated through any one access network upon access through another access network in a converged environment supporting different access networks. For example, upon access through a second access network, a terminal reuses authentication information authenticated during initial access through a first access network and resource information, such as an IP address, allocated during initial access through the first access network.

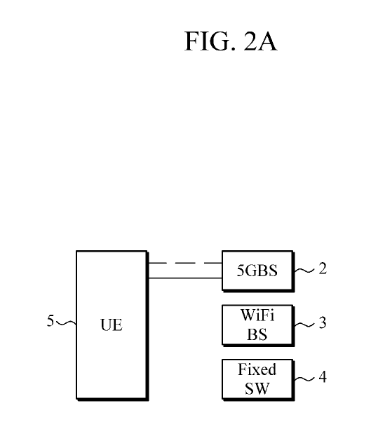

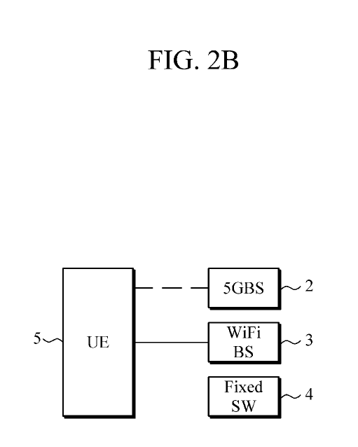

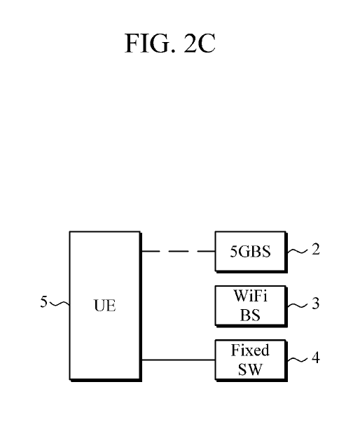

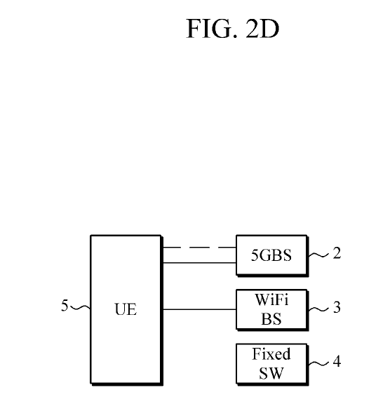

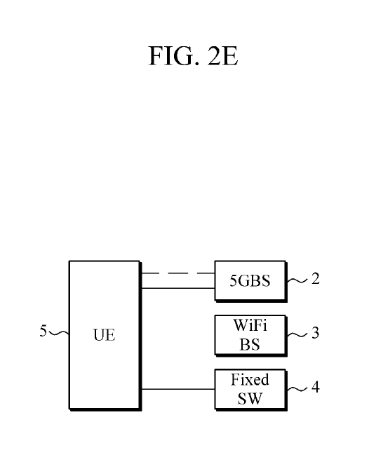

FIGS. 2A to 2E show examples of signaling and data connection paths for respective access networks in a converged network.

In FIGS. 2A to 2E, dashed lines denote signaling paths, and solid lines denote data paths. As shown in FIGS. 2A to 2E, all signaling paths are set to the 5GBS 2. In other words, 5G is used as a representative access network. While 5G is used as an example in this specification, a radio access technology, such as 3G, 4G, etc., which is used by a user by default may be used as a representative access network which is a signaling path.

FIG. 2A shows a case in which a user performs signaling and uses data through 5G, FIG. 2B shows a case in which a user performs signaling through 5G and uses data through WiFi, FIG. 2C shows a case in which a user performs signaling through 5G and uses data through Fixed, FIG. 2D shows a case in which a user performs signaling through 5G and uses data through both 5G and WiFi, FIG. 2E shows a case in which a user performs signaling through 5G and uses data through both 5G and Fixed. From the 5GBS 2/WiFiBS 3/FixedSW 4, a signaling path is connected to a UCE, and a data path is connected to a CGW.

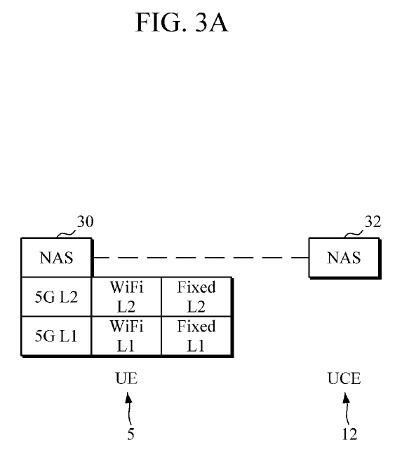

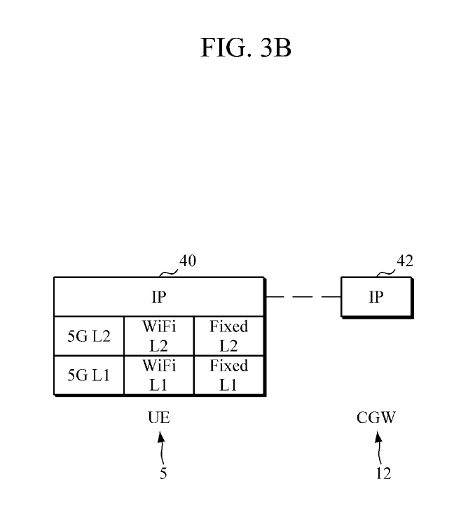

FIG. 3A is a structure diagram showing an example of a protocol stack for signaling according to an exemplary embodiment of the present invention.

Referring to FIG. 3A, the UE 5 and the UCE 12 have a non-access stratum (NAS) signaling relationship therebetween. An NAS 30 operates on the layer 2/layer 1 (L2/L1) of 5G among several access technology protocol stacks of the UE 5, and the NAS 30 of the UE 5 operates in conjunction with an NAS 32 of the UCE 12. FIG. 3A shows an example in which an NAS does not operate on WiFi or Fixed but only operates on 5G which is the representative access network, but an NAS operates on any one access network which is a representative access network. The NAS protocol provides functions for mobility management (MM) and session management (SM) between the UE 5 and the UCE 12. These functions include an authentication/security function or a resource allocation function.

FIG. 3B is a structure diagram showing an example of a protocol stack for data according to an exemplary embodiment of the present invention.

Referring to FIG. 3B, the UE 5 and a CGW 10 communicate using IP. An IP 40 operates on the L2/L1 of each access technology protocol stack of the UE 5, and the UE 5 uses IP resources 42 of the CGW 10. Communication from the UE 5 to the CGW 10 employs IP. During communication with a PDN at a rear end of the CGW 10, the CGW 10 serves as a gateway.

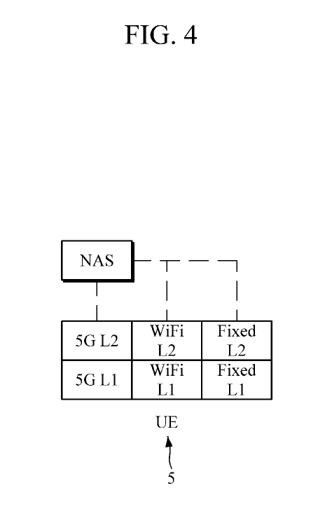

FIG. 4 is a reference diagram showing relationships between an NAS layer and respective access technologies.

Even when NAS signaling is only performed on 5G which is the representative access network as described above with reference to FIG. 3A, each access technology operates in conjunction with control information as shown in FIG. 4.

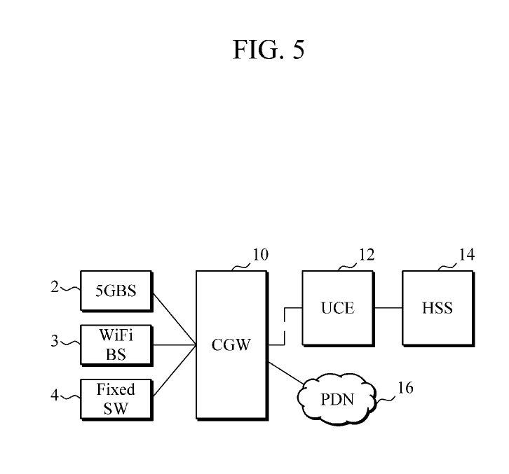

FIG. 5 is a structure diagram showing relationships between respective access technologies and a PDN according to an exemplary embodiment of the present invention.

Referring to FIG. 5, the 5GBS 2/WiFiBS 3/FixedSW 4 connect to a PDN 16 through a CGW 10. The 5GBS 2/WiFiBS 3/FixedSW 4 may be connected to the PDN 16 through the CGW 10 or may be directly connected to the PON 16. The UCE 12 has a control interface, authenticates a subscriber by receiving subscriber information from the HSS 14, and controls the CGW 10.

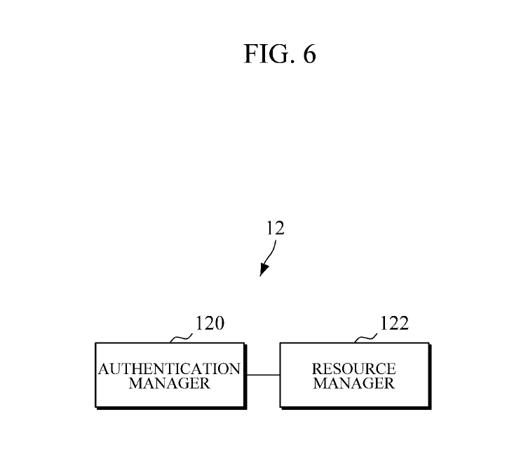

FIG. 6 is a block diagram of a UCE according to an exemplary embodiment of the present invention.

Referring to FIG. 6, the UCE 12 includes an authentication manager 120 and a resource manager 122.

The authentication manager 120 authenticates UE which requests a signaling connection with a converged core network through a first access network, and authenticates the UE, which gets access through a second access network to use a data service of the converged core network after the signaling connection is established, by reusing authentication information used to establish the signaling connection. The resource manager 122 transmits information on resource allocation to the UE which has requested the signaling connection through the first access network, thereby causing the UE to reuse the resource information upon access through the second access network. The resource information may be IP information of the UE.

The authentication manager 120 according to an exemplary embodiment generates and transmits a temporary identifier (ID) to the UE when the UE requests the signaling connection through the first access network. When a session creation request message including the temporary ID is received from the UE through the second access network, the authentication manager 120 authenticates the UE using the temporary ID included in the received session creation request message. Here, the temporary ID may be a globally unique temporary identifier (GUTI). The GUTI is an ID which is temporarily used based on an international mobile subscriber identity (IMSI) so that an IMSI of a user is not exposed. The GUTI may be periodically changed.

When the UE requests the signaling connection through the first access, the authentication manager 120 according to an exemplary embodiment exchanges index information of a cipher key with the UE and transfers the index information of the cipher key exchanged with the UE to the second access network. Accordingly, when the UE uses the data service through the second access network after the signaling connection is established, data is ciphered by reusing the index information of the cipher key in a section between the UE and the second access network.

When the UE requests the signaling connection through the first access network, the resource manager 122 according to an exemplary embodiment assigns an IP address of the UE and transmits a connection response together with the assigned IP address to the UE. Accordingly, when the UE uses a data service through the second access network after establishment of the signaling connection, the resource manager 122 causes the UE to reuse the IP address of the UE assigned upon establishment of the signaling connection.

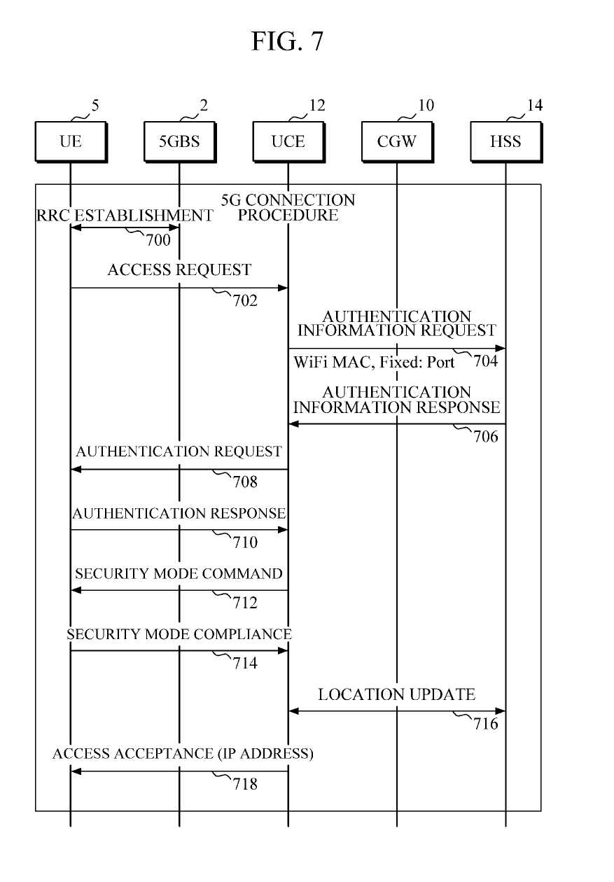

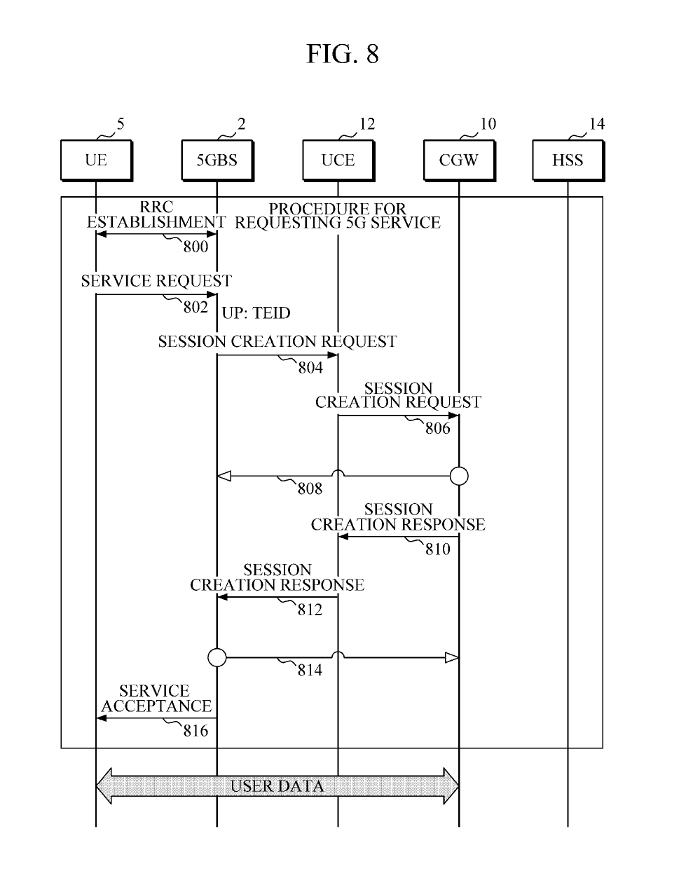

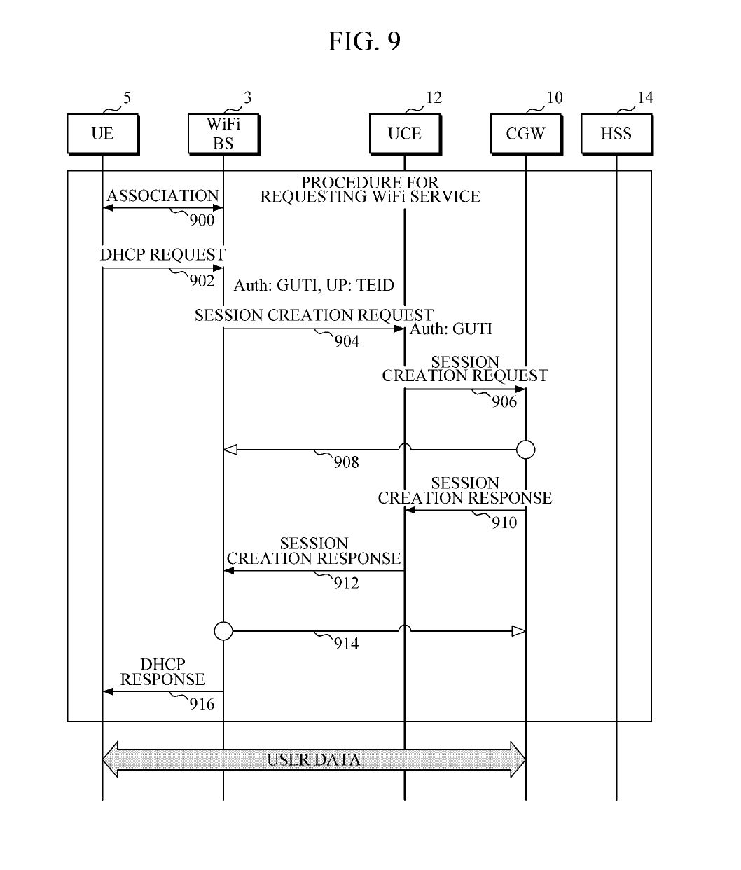

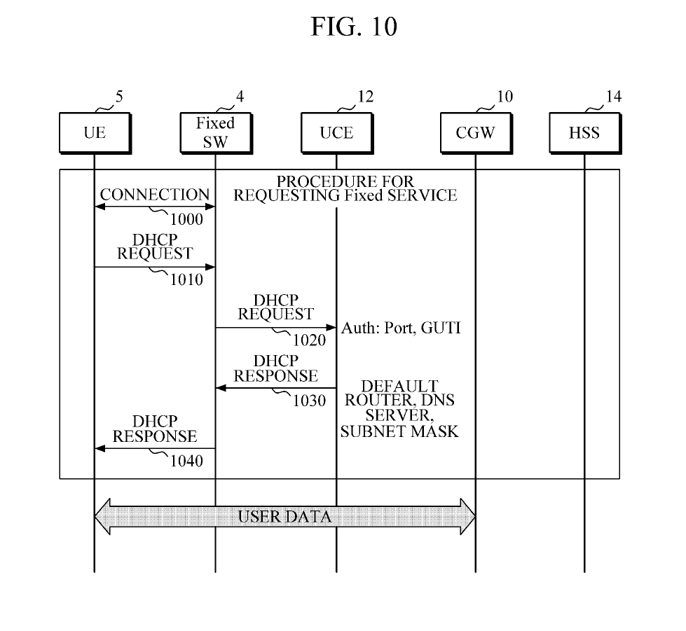

FIGS. 7 to 10 are sequence diagrams illustrating processes in which a user establishes a signaling connection through 5G and uses a data service through respective access networks. Specifically, FIG. 7 is a sequence diagram showing a process in which a user establishes a signaling connection through 5G, FIG. 8 is a sequence diagram showing a process in which a user uses data through 5G, FIG. 9 is a sequence diagram showing a process in which a user uses data through WiFi, and FIG. 10 is a sequence diagram showing a process in which a user uses data through Fixed.

Referring to FIG. 7, a user is authenticated and assigned an IP address through a 5G signaling connection. Referring to FIG. 8, the terminal uses a data service through 5G by reusing an authentication result of the terminal obtained in FIG. 7 and the IP address assigned to the terminal in FIG. 7. Meanwhile, referring to FIGS. 9 and 10, the terminal uses a data service through WiFi and Fixed by reusing the authentication result of the terminal and the IP address assigned to the terminal in FIG. 7. Processes in which the user establishes the signaling connection through 5G and uses a data service through the respective access networks will be described below with reference to FIGS. 7 to 10.

FIG. 7 illustrates a process in which the UE 5 establishes a radio resource connection (RRC) through the 5GBS 2 (700) and then NAS messages for access of the UE 5 are transmitted and received. After the RRC is established (700), the UE 5 transmits an access request (Attach Req) message to the 5GBS 2 (702), and the UCE 12 receiving the access request (Attach Req) message (702) transmits a subscriber information request (Auth Info Req) to the HSS 14 (704) and receives subscriber information (Auth Info Resp) from the HSS 14 (706). The subscriber information includes an authentication key of a subscriber. At this time, the UCE 12 may receive media access control (MAC) information for WiFi authentication or port information for Fixed authentication as well as the authentication key information of the subscriber. The UCE 12 transmits an authentication request (Auth Req) message to the UE 5 (708), and receives authentication information (Auth Resp) from the UE 5 (710). When transmitting the authentication request (Ruth Req) message (708), the UCE 12 may also transmit information for the UE 5 to generate the authentication key.

Subsequently, the UCE 12 authenticating the subscriber exchanges index information of cipher keys to be used for ciphering data through a security mode command procedure of transmitting a security mode command (Security Mode Cmd) message to the UE 5 (712) and receiving a security mode complete (Security Mode Cmpl) message from the UE 5 (714). Accordingly, the index information is shared between the UCE 12 and the UE 5, and signaling is performed in a way so that the UCE 12 and the UE 5 cipher data with one of cipher keys shared between them by exchanging the index information.

Subsequently, the UCE 12 stores a location of the subscriber (Location update) in the HSS 14 (716), assigns an IP address to the UE 5, and transmits the assigned IP address to the UE 5 through an access acceptance (AttachAccept) message (718). Meanwhile, for authentication of the UE 5, the UCE 12 may assign a temporary ID and transfer the assigned temporary ID to through the access acceptance message (718). Here, the temporary ID may be a GUTI. A GUTI is changed not only through an access procedure but also through other procedures. However, a change in the GUTI does not affect a method used in the present invention, and thus detailed description thereof will be omitted.

When the CGW 10 for providing a service to the UE 5 is changed, the UE 5 is reassigned an IP address. A CGW 10 which has control over the location of the UE 5 assigns the new IP address during an update of a tracking area. The tracking area of the UE 5 is periodically updated and may also be updated when a tracking area list received from a network is changed. When the UE 5 belongs to the range of the new CGW 10 through an update of the tracking area, the CGW 10 assigns a new IF address.

FIG. 8 is a sequence diagram showing a service request process for supporting, through the 5GBS 2, a data session for the UE 5 whose control connection has been completed through the 5GBS 2.

The process of FIG. 8 may be performed immediately after the connection process described above with reference to FIG. 7 or at an arbitrary moment at which there is user data after the signaling connection is set by the process described above with reference to FIG. 7. Establishment of an RRC (800) of FIG. 8 is setting of an RRC for transmitting data.

FIG. 8 illustrates a case in which there is data from the user, but when there is downlink data from a network, it is possible to instruct the UE 5 to request a service through a paging procedure. The UE 5 transfers a message, which has been, encoded using the authentication key assigned to the UE 5 in the process described above with reference to FIG. 7, to the converged core network, and the converged core network decodes the message using the key set in the process described above with reference to FIG. 7. When the decoding succeeds, the UE 5 is considered to be authenticated. Also, the UE 5 is identified using a GUTI, and the IP address assigned in the process described above with reference to FIG. 7 is used as the GUTI.

The UE 5 transmits a service request (Service Req) message to the 5GBS 2 (802), and the 5GBS 2 receiving the service request (Service Req) message of the UE 5 (802) assigns a tunnel endpoint ID (TEID) of a user plane and transmits a session creation request (Create Session Req) message including the assigned TEID to the UCE 12 (804). The UCE 12 transfers the session creation request message (Create Session Req) message including the TEID and received from the SGBS 2 to the CGW 10 (806).

Subsequently, the CGW 10 assigns a TEID to be received by the CGW 10 through an uplink and transmits a session creation response (Create Session Resp) message including the TEID to the UCE 12 (810), and the UCE 12 transfers the session creation response (Create Session Resp) message including the TEID and received from the CGW 10 to the 5GBS 2 (812). In this way, a bidirectional (upward and downward) tunnel is established between the 5GBS 2 and the CGW 10 (808 and 814). The 5GBS 2 receiving the session creation response (Create Session Resp) message from the UCE 12 (812) transmits a service acceptance (Service Accept) message to the UE 5 (816).

Thus far, a service request process has been described based on a tunnel, but may also be performed by updating a routing table between the 5GBS 2 and the CGW 10. In other words, the CGW 10 receiving the session creation request (Create Session Req) message (806) registers a routing path to the 5GBS 2 in a routing table of the CGW 10 with respect to an IP address of the UE 5, and the 5GBS 2 receiving the session creation response (Create Session Resp) message (812) registers a routing path to the CGW 10 in a routing table of 5GBS 2 with respect to the IP address of the UE 5, so that the same effect as establishment of a bidirectional tunnel may be obtained.

FIG. 9 illustrates a service request procedure for supporting, through the WiFiBS 3, a data session for the UE 5 whose control connection has been completed through the SGBS 2.

The process of FIG. 9 may be performed immediately after the connection process described above with reference to FIG. 7 or at an arbitrary moment at which there is user data after the signaling connection described above with reference to FIG. 7 is set. After an L2 association is made between the UE 5 and the WiFiBS 3 (900), the UE 5 requests a service by transmitting a dynamic host configuration protocol (DHCP) request (DHCP Req) message to the WiFiBS 3 (902). At this time, the GUTI which is the temporary ID assigned in the process described above with reference to FIG. 7 is inserted in a source IP address of the DHCP request (DHCP Req) message. In this case, the WiFiBS 3 may obtain a MAC address of the UE 5 in an L2 frame containing the DHCP request (DHCP Req) message received from the UE 5.

The WiFiBS 3 includes the GUTI included in the DHCP request (DHCP Req) message and the MAC address of the UE 5 obtained from the DHCP request (DHCP Req) message in a session creation request (Create Session Req) message and transmits the session creation request (Create Session Req) message to the UCE 12 (904). At this time, the WiFiBS 3 assigns a TEID of a user plane and also transmits the assigned TEID to the UCE 12. The UCE 12 authenticates the UE 5 through the GUTI and the MAC address included in the session creation request (Create Session Req) message received from the WiFiBS 3.

When the authentication succeeds, the UCE 12 transfers the session creation request (Create Session Req) message and the TEID received from the WiFiBS 3 to the CGW 10 (906). The CGW 10 assigns a TEID to be received by the CGW 10 through an uplink and transmits a session creation response (Create Session Resp) message including the TEID to the UCE 12 (910), and the UCE 12 transfers the session creation response (Create Session Resp) message including the TEID and received from the CGW 10 to the WiFiBS 3 (912). In this way, a bidirectional (upward and downward) tunnel is established between the WiFiBS 3 and the CGW 10 (908 and 914). The WiFiBS 3 receiving the session creation response (Create Session Resp) message from the UCE 12 (912) transmits a DHCP response (DHCP Ack) message to the UE 5 (916). At this time, the IP address of the UE 5 assigned in the process described above with reference to FIG. 7 is assigned as an address of the UE 5 included in the DHCP response (DHCP Ack) message.

As a key for ensuring the integrity of data of a wireless section between the UE 5 and the WiFiBS 3 and ciphering the data, the index information of the cipher key exchanged in the process described above with reference to FIG. 7 may be reused. To this end, it is necessary to transfer the index information of the cipher key that the 5GBS 2 has to the WiFiBS 3. The UCE 12 may transfer the index information of the cipher key to the WiFiBS 3 through the session creation response (Create Session Resp) message, or the 5GBS 2 may transfer the index information of the cipher key to the WiFiBS 3.

Thus far, a service request process has been described based on a tunnel, but may also be performed by updating a routing table between the WiFiBS 3 and the CGW 10. In other words, the CGW 10 receiving the session creation request (Create Session Req) message (906) registers a routing path to the WiFiBS 3 in the routing table of the CGW 10 with respect to the IP address of the UE 5, and the WiFiBS 3 receiving the session creation response (Create Session Resp) message (912) registers a routing path to the CGW 10 in a routing table of WiFiBS 3 with respect to the IP address of the UE 5, so that the same effect may be obtained as if a bidirectional tunnel had been established.

FIG. 10 illustrates a service request procedure for supporting, through the FixedSW 4, a data session for the UE 5 whose control connection has been completed through the 5GBS 2. The process of FIG. 10 may be performed immediately after the connection process described above with reference to FIG. 7 or at an arbitrary moment at which there is user data after the signaling connection is set in the process described above with reference to FIG. 7. After an L2 association is made between the UE 5 and the FixedSW 4 (1000), the UE 5 requests a service by transmitting a DHCP request (DHCP Req) message to the FixedSW 4 (1010). At this time, the GUTI assigned in the process described above with reference to FIG. 7 is inserted in a source IP address of the DHCP request (DHCP Req) message. The FixedSW 4 may obtain a MAC address of the UE 5 in an L2 frame containing the DHCP request (DHCP Req) message received from the UE 5.

The FixedSW 4 includes the GUTI and the MAC address of the UE 5 in the DHCP request (DHCP Req) message and transmits the DHCP request (DHCP Req) message to the UCE 12 (1020). At this time, the UCE 12 authenticates the UE 5 through the GUTI and the MAC address included in the DHCP request (DHCP Req) message received from the FixedSW 4.

When the authentication succeeds, the UCE 12 transfers a DHCP response (DHCP Resp) message to the FixedSW 4 (1030). Here, the DHCP response (DHCP Resp) message may include a default router, a domain name system (DNS) server, a subnet mask, and so on. The FixedSW 4 receives the DHCP response (DHCP Resp) message from the UCE 12 (1030) and then transmits a DHCP response (DHCP Ack) message to the UE 5 (1040). Here, the IP address of the UE 5 assigned in the process described above with reference to FIG. 7 may be assigned as an address of the UE 5 included in the DHCP response (DHCP Ack) message.

Only a part of an overall DHCP procedure related to the present invention has been described as the above DHCP procedure, and the 5GBS 2/WiFiBS 3/FixedSW 4 operate as a DHCP relay agent or a DHCP proxy agent in the DHCP procedure. In the present invention, it has been described that the UCE 12 operates as a DHCP server. However, the UCE 12 may also operate as a DHCP relay agent or a DHCP proxy agent, and there may be a separate DHCP server. A DHCP server serves to dynamically assign an IP address and other relevant configuration details to a terminal.

Thus far, the DHCP has been described as an example. However, even when a protocol other than the DHCP is used, as long as information authenticated through a representative access network and an IP address assigned through the representative access network are reused, it is possible to apply a method of the present invention as is.

Further, a method of establishing a tunnel between the FixedSW 4 and the CGW 10 may also be applied to Fixed as described above with reference to FIG. 9, and a method of the present invention may also be applied to WiFi without tunnel establishment as described above with reference to FIG. 10.

According to an exemplary embodiment, in a converged environment having various access networks, authentication information authenticated and resource information allocated through any one access network is reused in another access network, so that a user may use services including selection of an access network, handover between access networks, data aggregation from two or more access networks, etc. regardless of access networks while using various access networks.

During a handover between different access networks, it is possible to minimize a delay occurring due to re-authentication and continue a session which has been underway before the handover without changing an address. Further, even when access networks differ from each other, it is possible to reuse authentication information for a previous access network without additional authentication.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of using a converged core network, the method comprising:
establishing, by a terminal, a signaling connection with a converged core network supporting a plurality of access networks through a first access network; and
after establishing the signaling connection, using, by the terminal, a data service through a second access network by reusing at least one of authentication information authenticated and resource information allocated upon establishing the signaling connection through the first access network.

2. The method of claim 1, wherein the using of the data service includes authenticating the terminal for use of the data service through the second access network, and
the terminal is authenticated when the terminal transmits a message encoded using an authentication key assigned by the converged core network upon the terminal's establishment of the signaling connection through the first access network to the converged core network through the second access network and the converged core network decodes the message received from the terminal using the authentication key assigned by the converged core network upon the terminal's establishment of the signaling connection through the first access network.

3. The method of claim 1, wherein the using of the data service includes:
transmitting, by the terminal, a service request including a temporary identifier (ID) to the second access network, and transmitting, by the second access network, a session creation request message including the temporary ID to a universal control entity (UCE); and
authenticating, by the UCE, the terminal using the temporary ID included in the session creation request message received from the second access network, and
wherein the temporary ID is information generated and transmitted to the terminal by the UCE when the terminal requests the signaling connection through the first access network.

4. The method of claim 3, wherein the temporary ID is a globally unique temporary identifier (GUTI).

5. The method of claim 3, wherein the using of the data service further includes:
identifying, by the second access network, a media access control (MAC) address of the terminal in a frame including a service request message; and
authenticating, by the UCE, the terminal using the identified MAC address together with the temporary ID.

6. The method of claim 1, wherein the using of the data service includes transmitting, by the second access network, a service response to a service request of the terminal to the terminal, assigning an address identical to an Internet protocol (IP) address assigned to the terminal by a universal control entity (UCE) upon the terminal's establishment of the signaling connection through the first access network, and transmitting the address through the service response.

7. The method of claim 1, wherein the using of the data service includes ciphering data of a section between the terminal and the second access network when the second access network receives, from a universal control entity (UCE), index information of a cipher key exchanged between the terminal and the UCE upon the terminal's establishment of the signaling connection through the first access network and reuses the index information, or the second access network receives the index information of the cipher key from the first access network and reuses the index information.

8. The method of claim 1, wherein the establishing of the signaling connection includes:
transmitting, by the terminal, a connection request message to a universal control entity (UCE);
requesting, by the UCE receiving the connection request message, subscriber information from a home subscriber server (HSS) and receiving subscriber information from the HSS;
transmitting, by the UCE, an authentication request message including authentication key information in the subscriber information to the terminal and receiving the authentication information from the terminal; and
assigning, by the UCE authenticating a subscriber, an Internet protocol (IP) address to the terminal and transmitting an access acceptance message including the assigned IP address to the terminal.

9. The method of claim 8, wherein the subscriber information includes media access control (MAC) information for wireless fidelity (WiFi) authentication or port information for Fixed authentication together with the authentication key information of the subscriber.

10. The method of claim 8, wherein the establishing of the signaling connection further includes exchanging, by the UCE authenticating the subscriber, index information of a cipher key to be used for ciphering data with the terminal through a security mode command procedure.

11. The method of claim 8, wherein the establishing of the signaling connection further includes, for authentication of the terminal, assigning, by the UCE, a temporary identifier (ID) and transferring the assigned temporary ID to the terminal through the access acceptance message.

12. The method of claim 1, further comprising establishing a bidirectional tunnel between the second access network and a converged gateway (CGW) using a tunnel end identifier (TEID).

13. The method of claim 1, further comprising:
registering, by a converged gateway (CGW), a routing path to an Internet protocol (IP) address of the terminal through a second delivery network in a routing table of the CGW, and
registering, by the second delivery network, a routing path to the IP address of the terminal through the CGW in a routing table of the second delivery network.

14. The method of claim 1, wherein the first access network is a representative access network among a mobile communication network, a wireless communication network, and a wired communication network,
the second access network is at least one of a mobile communication network, a wireless communication network, and a wired communication network, and
the first access network and the second access network are identical to or different from each other.

15. A universal control entity (UCE) comprising:
an authentication manager configured to authenticate a terminal requesting a signaling connection with a converged core network through a first access network, and authenticate the terminal, which connects to the converged core network through a second access network to use a data service of the converged core network after the signaling connection is established, by reusing authentication information used to establish the signaling connection; and
a resource manager configured to transmit information on resource allocation to the terminal requesting the signaling connection through the first access network, and cause the terminal to reuse the resource information upon access through the second access network.

16. The UCE of claim 15, wherein the authentication manager generates and transmits a temporary identifier (ID) to the terminal when the terminal requests the signaling connection through the first access network, and authenticates, when a session creation request message including the temporary ID is received from the terminal through the second access network after the signaling connection is established, the terminal using the temporary ID included in the received session creation request message.

17. The UCE of claim 15, wherein the authentication manager exchanges index information of a cipher key with the terminal when, the terminal requests the signaling connection through the first access network, and transfers the index information of the cipher key exchanged with the terminal to the second access network, so that data is ciphered by reusing the index information of the cipher key in a section between the terminal and the second access network when the terminal uses the data service through the second access network after the signaling connection is established.

18. The UCE of claim 15, wherein the resource manager assigns an Internet protocol (IP) address to the terminal when the terminal requests the signaling connection through the first access network, and transmits a connection response together with the assigned IP address to the terminal, so that the assigned IP address of the terminal is reused when the terminal uses the data service through the second access network after the signaling connection is established.

19. A converged core network system comprising:
a terminal;
a plurality of access networks to which the terminal connects; and
a converged core network configured to support the plurality of access networks and provide a data service to the terminal through a second access network by reusing at least one of authentication information authenticated and resource information allocated when the terminal establishes a signaling connection with the converged core network through a first access network.
